(19) United States
(12) Patent Application Publication
(10) Pub. No.: US 2006/0120112 A1
(43) Pub. Date: Jun. 8, 2006

(54) Backlight module and light guide plate with integrated frame

(75) Inventors: Ping Jung Lin, Miao-Li (TW); Hsueh Tien Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/293,975

(22) Filed: Dec. 5, 2005

(30) Foreign Application Priority Data
Dec. 3, 2004 (TW) 93219542

(51) Int. Cl. F21V 7/04

(52) U.S. Cl. 362/626

(57) ABSTRACT

A backlight module (3) includes a light guide plate (2) and a light source (36). The light guide plate includes a light guide portion (20) and a frame portion (22) integrated with the light guide portion. The light source is arranged within the light guide portion. The light guide portion includes a light incident surface (240), a top surface (244) adjacent to the light incident surface, and a bottom surface (242) adjacent to the light incident surface. Each of the top and bottom surfaces may include an array of light diffusion concavities (246) or protrusions. The backlight module has a simple, reliable structure, and the cost of manufacture and assembly is reduced. In addition, the backlight module has improved light utilization.

### BACKGROUND

1. Field of the Invention

The present invention relates to a light guide plate and a backlight module using the same, and especially to a light guide plate and a backlight module for a liquid crystal display (LCD).

2. General Background

Liquid crystal displays are commonly used as display devices for compact electronic apparatuses, because they not only provide good quality images with little power but also are very thin. The liquid crystals in a liquid crystal display cannot emit light themselves. The liquid crystals need be lit by a light source, so as to clearly and sharply display text and images. Thus, a backlight module for an LCD is generally needed.

FIG. 4 shows a typical backlight module for an LCD. The backlight module 1 includes two prism films 16, a polarizer 15, a light guide plate (LGP) 14, a plastic frame 11, and a reflective film 13 arranged together. The backlight module 1 further includes a light source 17, and a flexible printed circuit (FPC) 12 for supplying power to the light source 17. The LGP 14 is arranged in the plastic frame 11.

In the assembly of the backlight module 1, the LGP 14 is placed in the plastic frame 11 manually. That is, the LGP 14 is generally touched by an operator's hands, which can result in contamination of or damage to the LGP 14. Further, the LGP 14 may be scraped by the plastic frame 11, and particles dislodged by this contact may become attached to the LGP 14. These problems frequently result in lower yield rates, more man-hours, and higher costs. Furthermore, unduly large clearances may exist between the plastic frame 11 and the LGP 14, which may reduce the light utilization rate and the brightness of the backlight module 1.

What is needed, therefore is an LGP and a backlight module that can be manufactured without damage at low cost.

### SUMMARY

In one embodiment, a light guide plate includes a light guide portion and a frame portion integrated with the light guide portion.

In another embodiment, a backlight module includes a light guide plate and a light source. The light guide plate includes a light guide portion and a frame portion integrated with the light guide portion. The light source is arranged within the light guide portion. The light guide portion includes a light incident surface, a top surface adjacent to the light incident surface, and a bottom surface adjacent to the light incident surface. Each of the top and bottom surfaces may include an array of light diffusion concavities or protrusions. The backlight module has a simple, reliable structure, and the cost of manufacture and assembly is reduced. In addition, the backlight module has improved light utilization.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric view of an LGP according to a preferred embodiment of the present invention;

FIG. 2 is a schematic, inverted, cross-sectional view of a transmission area of a light guide portion of the LGP of FIG. 1, corresponding to line II-II thereof;

FIG. 3 is an isometric view of a backlight module including the LGP of FIG. 1; and

FIG. 4 is an exploded, isometric view of a conventional backlight module.

### DETAILED DESCRIPTION OF PREFERRED EMBODIMENTS

Reference will now be made to the drawings to describe the preferred embodiments in detail.

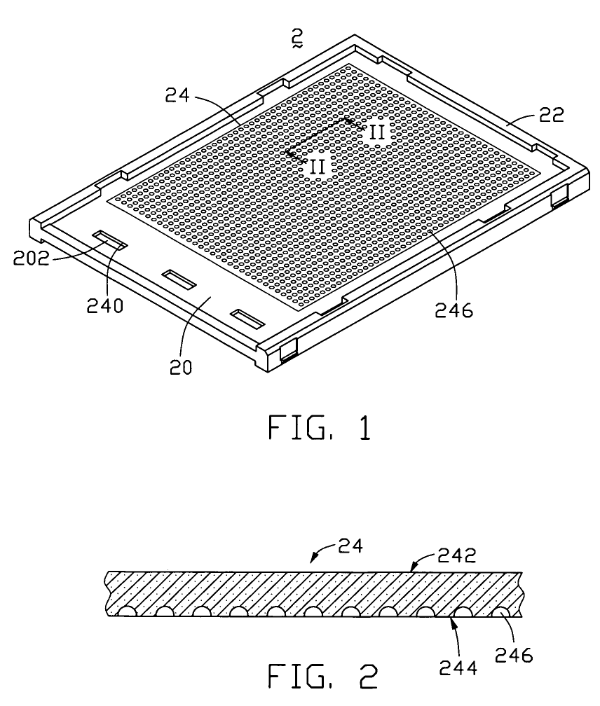

Referring to FIG. 1 and FIG. 2, an LGP 2 according to a preferred embodiment of the present invention includes a light guide portion 20 and a frame portion 22 integrated with the light guide portion 20. The light guide portion 20 includes a transmission area 24, and a plurality of cavities 202 located adjacent to the transmission area 24. The transmission area 24 includes a plurality of side surfaces 240, a top surface 244 adjoining the side surfaces 240 and serving as a light emitting surface, and a bottom surface 242 opposite to the top surface 244 and serving as a reflective surface. The side surfaces 240 are adjacent to the plurality of cavities 202 respectively. The bottom surface 242 includes a plurality of light diffusion structures 246 formed thereat for diffusing light. In the illustrated embodiment, the light diffusion structures 246 comprise an array of concavities. In alternative embodiments, the light diffusion structures 246 may comprise an array of protrusions. The light diffusion structures 246 can improve the uniformity of light emitting from the top surface 244. That is, the light guide portion 20 can receive light from the side surfaces 240, and emit light from the top surface 244 uniformly. The light guide portion 20 can be made from polymethyl methacrylate (PMMA) or polycarbonate (PC). The frame portion 22 surrounds a plurality of side extremities (not shown) of the light guide portion 20. The frame portion 22 can support the light guide portion 20, as well as other optical components positioned on the LGP 2. Such optical components may for example be a prism sheet (not shown in FIGS. 1 and 2) and/or a polarizer sheet (not shown in FIGS. 1 and 2). The frame portion 22 can be made from plastic material, such as black and/or white polycarbonate. The LGP 2 can be fabricated by injection molding after an integrated mold (not shown) of the light guide portion 20 and the frame portion 22 is made.

Whereas the light guide portion 20 and the frame portion 22 are integrated, a simple structure without accessories such as clips can be achieved. The assembling process can be shortened, and the cost of manufacturing reduced. Furthermore, the transmission area 24 at the light diffusion structures 246 including the bottom surface 242 has little or no contact from human hands, which helps prevent the light diffusion structures 246 from being contaminated or damaged. Moreover, the elimination of clearances between the light guide portion 20 and the frame portion 22 provides an improvement in the light utilization rate.

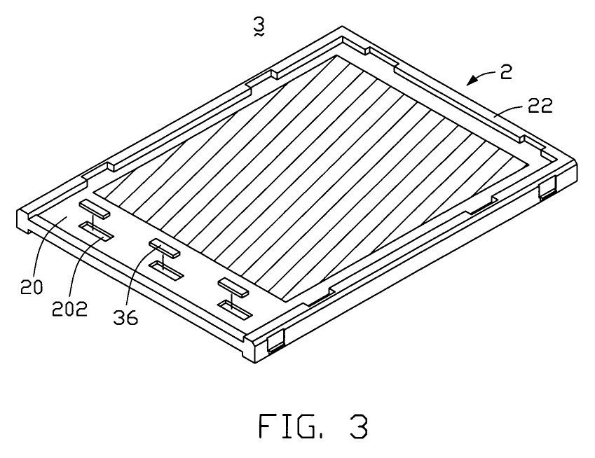

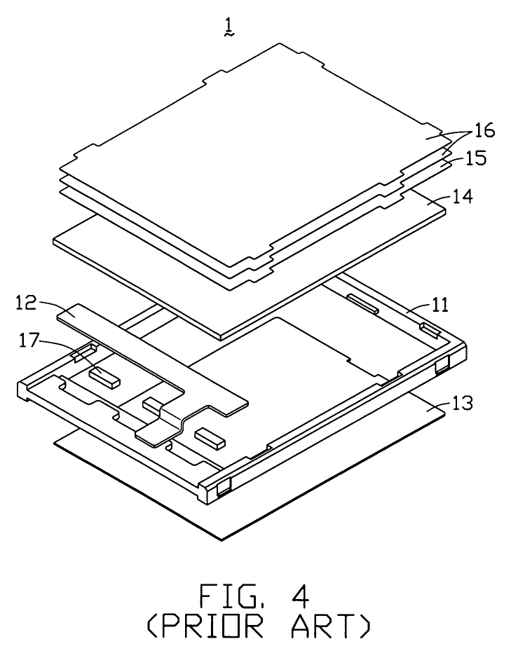

FIG. 3 shows a backlight module of a preferred embodiment of the present invention. The backlight module 3 includes the LGP 2 and a light source 36. The light source 36 includes a plurality of point light sources, which are typically light emitting diodes (LEDs). Each LED is arranged in a respective cavity 202 of the light guide portion 20. Light beams from the light source 36 enter the transmission area 24 through the side surfaces 240, and then are emitted from the top surface 242 uniformly.

In various embodiments, the backlight module 3 can further include a prism sheet, a diffusing sheet, a reflective sheet, and/or a polarizer. In the embodiment shown in FIG. 3, one such sheet and/or polarizer is positioned on the transmission area 24, such that the light diffusion structures 246 of the transmission area 24 are not visible. In various alternative embodiments, the frame portion 22 can be made from metallic material such as Al or Fe. The top surface 242 can include a plurality of light diffusion structures for improving the uniformity of the emitted light. The light source 36 can be a single linear light source, such as a cold cathode fluorescent lamp (CCFL). In such case, the cavities 202 are replaced by a single elongate cavity.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate, comprising:
a light guide portion, and
a frame portion integrated with the light guide portion.

2. The light guide plate as claimed in claim 1, wherein the light guide portion comprises a bottom surface having a plurality of light diffusion structures formed thereat.

3. The light guide plate as claimed in claim 1, wherein the light guide portion comprises a top surface having a plurality of light diffusion structures formed thereat.

4. The light guide plate as claimed in claim 1, wherein the light guide portion comprises a transmission area.

5. The light guide plate as claimed in claim 4, wherein the light guide portion further comprises a cavity adjacent to the transmission area.

6. The light guide plate as claimed in claim 1, wherein the light guide portion is made from polymethyl methacrylate.

7. The light guide plate as claimed in claim 1, wherein the light guide portion is made from polycarbonate.

8. The light guide plate as claimed in claim 1, wherein the frame portion surrounds a plurality of side extremities of the light guide portion.

9. The light guide plate as claimed in claim 1, wherein the frame portion is made from plastic material.

10. The light guide plate as claimed in claim 9, wherein the frame portion is made from polycarbonate.

11. The light guide plate as claimed in claim 1, wherein the frame portion is made from metallic material.

12. A backlight module, comprising:
a light guide plate comprising:
a light guide portion; and
a frame portion integrated with the light guide portion; and
a light source arranged within the light guide portion.

13. The backlight module as claimed in claim 12, wherein the light source is a point light source.

14. The backlight module as claimed in claim 13, wherein the point light source is a light emitting diode.

15. The backlight module as claimed in claim 12, wherein the light source is a linear light source.

16. The backlight module as claimed in claim 15, wherein the linear light source is a cold cathode fluorescent lamp.

17. A backlight module comprising:
a planar type light guide portion, and
a frame portion surrounding the light guide portion; wherein
both light guide portion and said frame are simultaneously formed by injection molding.
